(19) United States
(12) Patent Application Publication
(10) Pub. No.: US 2006/0088027 A1
(43) Pub. Date: Apr. 27, 2006

(54) Dynamic log for computer systems of server and services

(76) Inventor: Wolfgang Becker, Ludwigshafen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/173,000

(22) Filed: Jul. 5, 2005

(30) Foreign Application Priority Data
Jul. 7, 2004 (EP) 04 015 971.7
Sep. 9, 2004 (EP) 04 104 365.4

(51) Int. Cl. H04L 12/66

(52) U.S. Cl. 370/352

(57) ABSTRACT

The administration of a computer system of server and services is supported by providing entries in an administration log. The log helps to track the cause of a failed service to the relevant setup change of a server. In one aspect, the steps for perform such a tracking includes receiving input data that describe a setup change of a server and input date that identify the server, determining the service that is affected by the setup change, and writing a log entry that includes the input data and the identification of the affected service. In a further aspect, writing of the log entry is done in two parts, where the first part includes the input data that identify the server, the affected services, and a navigation link to the second part and where the second part includes the input data that describe the setup change.

### TECHNICAL FIELD

The present invention generally relates to the field of administrating a computer system of server and services and more particularly to providing entries in an administration log.

### RELATED APPLICATIONS

This application claims priority to European Patent Application No. 04 015 971.7, titled “Dynamic Log for Computer Systems of Server and Services,” filed Jul. 7, 2004, and European Patent Application No. 04 104 365.4, titled “Dynamic Log for Computer Systems of Server and Services,” filed Sep. 9, 2004. The content of both aforementioned applications are incorporated herein by reference.

### BACKGROUND

A computer system of server and services consists of at least one server and a plurality of services provided by the server. In one possible arrangement, one server provides one or more services. In another arrangement, different servers provide a single service. It is also possible for a system to include a mixture of both types of arrangements.

If a system includes a large number of servers and services, as systems often do in large and medium-sized enterprises, administration of the system becomes challenging and may require several administrators. Frequently, different administrators are responsible for administrating different aspects of the system. One aspect may be administration of data that describes a setup of a server. This data may be specific for that server. Another aspect may be administration of services, which are application programs for end users.

In a system of server and services, problems such as failed services or services operating in an unexpected way due to setup changes of the server may occur. The problem may be more complicated if the system is large and the administration of the server is performed separately from the administration of the services. In such cases, the administrator responsible for a service often does not have sufficient information to find the cause of a failure of the service. More specifically, it may be difficult for the administrator to associate the failed service to the relevant server setup changes that had caused the failure.

### SUMMARY

Consistent with a principle of the present invention, a method is provided that enables tracking of the cause of failed services to its relevant setup changes. In one embodiment of the invention, relevant information about the server setup changes is provided. The setup change information is then associated with the status of the services within a central log. If a service encounters a problem during operation, the central log may be searched for entries that associate the service with a server setup change. Following the search, the setup change data may be inspected in order to find the setup change that is responsible for the error.

Consistent with another principle of the present invention, a method is provided that enables administration of a system of at least one server and a plurality of services provided by the server. The method includes three steps. The first step is receiving of input data that describe a setup change of the server of the system and identify the server for which the setup is changed. The second step is determining which of the service or services are affected by the setup change. This step may be done by analyzing the relations between servers and services of the system, where each of the relations defines which server provides each of the services. The third step is the writing of a log entry, where the log entry includes input data identifying the server, identification of the determined service, and input data describing the setup change. The resulting log may be used as a tool for administrating the system of server and services and for providing the information for tracking a service failure to the responsible setup change of a server.

Consistent with another principle of the present invention, a method is provided for writing the input data that identify the server, the identification of the determined service, and the input data that describe the setup change into the log in a special way. Specifically, the information is split into two parts, where the first part contains the identified server and determined services together with a navigation link to the second part, and where the second part contains the input data that describe the setup change. In accordance with this aspect of the invention, the first part may be written into a log entry while the second part may be accessed from the log entry using the navigation link.

Consistent with yet another principle of the present invention, a machine-readable medium is provided on which a computer program comprising program instructions for causing a computer to perform the above-mentioned methods is stored.

Further features and embodiments of the present invention will become apparent from the description and the accompanying drawings. It will be understood that the features mentioned above and those described hereinafter can be used not only in the combination specified but also in other combinations or on their own, without departing from the scope of the present invention. It will also be understood that the foregoing background and summary and the following description of the embodiment are in no way limiting on the scope of the present invention and are merely illustrations of a preferred embodiment of the present invention.

### BRIEF DESCRIPTION OF DRAWINGS

The accompanying drawings, which are incorporated in and constitute a part of this specification, illustrate one embodiment of the present invention and together with the description, serve to explain the principles of the operation of the embodiment.

FIG. 1 is a flow diagram that illustrates the creation process of a log entry in accordance with the present invention.

FIG. 2 illustrates an example of a system of server and services in accordance with the present invention.

FIG. 3 illustrates an example of a log entry in accordance with the present invention.

FIG. 4 illustrates another example of a log entry in accordance with the present invention.

FIG. 5 illustrates an example of a log entry having additional details in accordance with the present invention.

### DETAILED DESCRIPTION

Reference will now be made in detail to the present embodiments of the invention, an example of which is illustrated in the accompanying drawings. Wherever possible, the same reference numbers will be used throughout the drawings to refer to the same or like parts.

In one possible embodiment, administration of the system of server and services includes administration of objects of different levels such as administration and maintenance of hardware of the server, operating systems of the server, system programs of the server, and application programs. Frequently, different administrators are responsible for administrating different levels of the system and their skill sets are specialized for a particular level. On the other hand, objects of a particular level of the system are often influenced by objects of other levels. This is typical for the levels of services that depend on objects of other levels. Here, the term services is used to describe application programs that provide a service to end users and depend on objects of other levels. Examples of such services include application programs that provide information about the employees of a company. Administration of services usually includes starting and stopping of the application programs and administration of users who have access to the individual services. In contrast to services, data describing a setup of a server are objects of the levels below the service level. Examples of data describing the setup of the server include system files. Administration of the system files usually includes modification of these files.

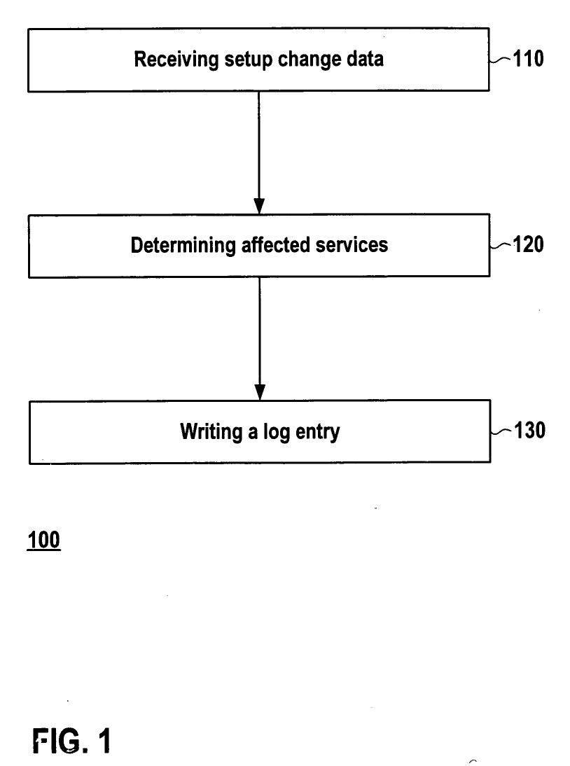

FIGS. 1-3 include elements like server, service, and log entry. FIG. 1 is a flow diagram that illustrates the creation process of a log entry in accordance with the present invention. The process begins with receiving of setup change data 110 and continues with the determining of the affected services 120. The process finishes with the writing of a log entry 130. In a suitable embodiment for providing input data for the receiving step 110, a program is used for automatically detecting and identifying changes of system and configuration files of servers. Such changes are examples of server setup changes. A program of this kind may, for example, monitor the status of relevant files of a server and detect if any of the files are changed. In the event that a file is changed, the change data may be created so that they include the file name, the file path, and the changed content of the file. The changed content may be described by specifying the position of the modified content in the file and stating, for the modified content, the versions before and after the change. Such a description of the changed content is advantageous because it minimizes the size of the description, allows identification of all changes, and provides the information required to take back any implemented file changes. Using this description, the monitoring program automatically provides the change data and the server identification as input data for the receiving step 110.

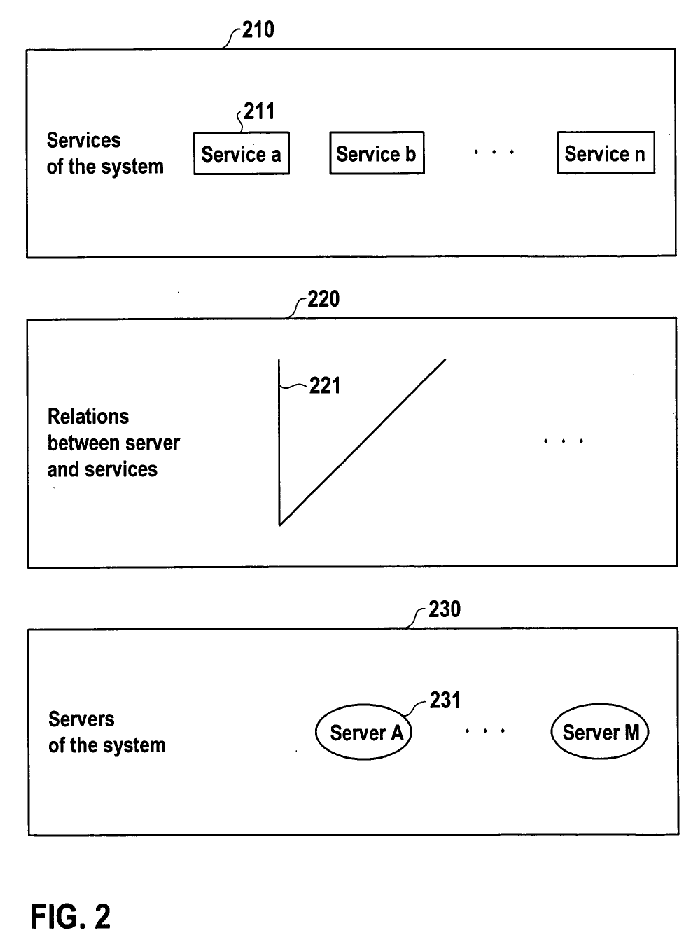

FIG. 2 shows an example of a system having multiple services 210 and multiple servers 230. The relations 220 between the services and the servers define which service is running on which server. In FIG. 2, a single relation is depicted by a single line, as shown in the example of relation 221 between service a 211 and server A 231. The determining step 120 (FIG. 1) determines the service that is affected by the setup change by taking the server for which the change data have been received and analyzing the relations between that server and the services. Assuming that only service a and service b are running exclusively on server A. It follows that changing the setup of server A affects service a and service b and no other services. In a suitable embodiment, a list having two columns is provided, where the first column is for server identifications and the second column is for service identifications. Each entry in the list describes one relation between the server and the service. The determining step of FIG. 1 includes searching the list for entries for a server identification that is identical to the received server identification and registering the service identifications of the found entries as the determined services.

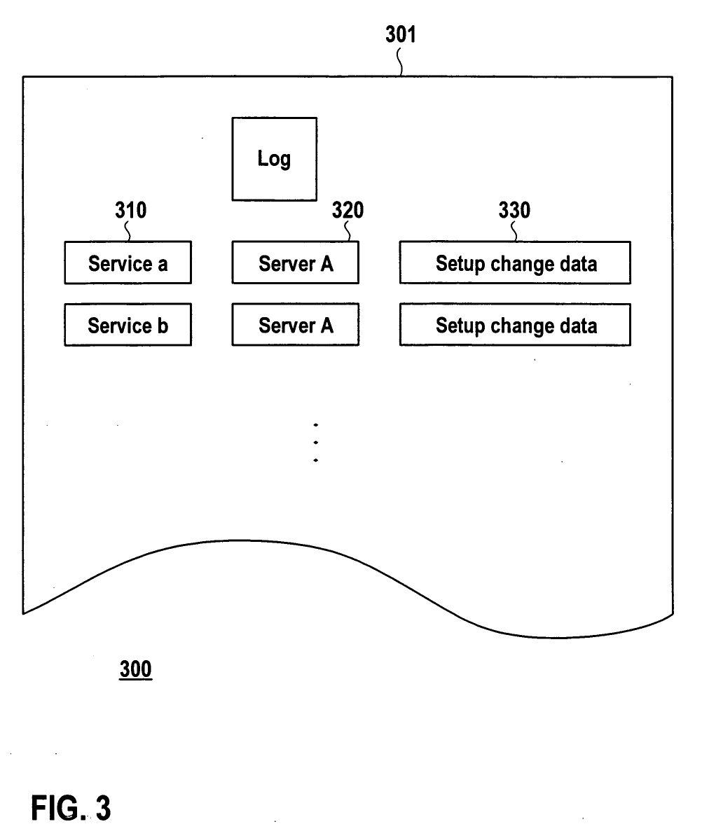

FIG. 3 shows a log 301 with two entries that have resulted from writing step 130. Log 301 includes a minimal amount of information, including the identification of the server 320, which was received as a part of the input data, the determined service 310 that is affected by the change, and the setup change data 330, which were also received in the input data.

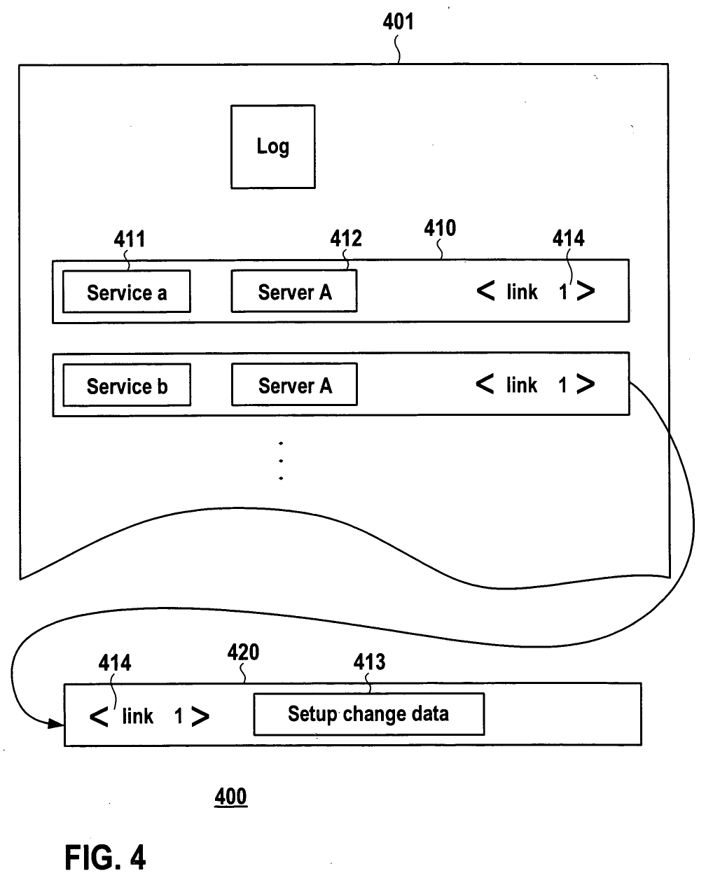

FIG. 4 shows a log 401 with two entries. The log entries include the received identification of a server 412, the identification of a determined service 411, and a navigation link 414 for accessing received setup change data 413. In this case, the received change data for the log entry 410 are accessible through the navigation link. In a suitable embodiment, the data 420, which are accessible with the navigation link, are displayed in a separate window. The advantage of such a data structure is that it allows the change data, which may comprise a large amount of information, to be stored separately, thereby increasing the clarity of the log entries. In addition, less memory is required as the change data have only to be stored once even when there are two or more log entries for one setup change.

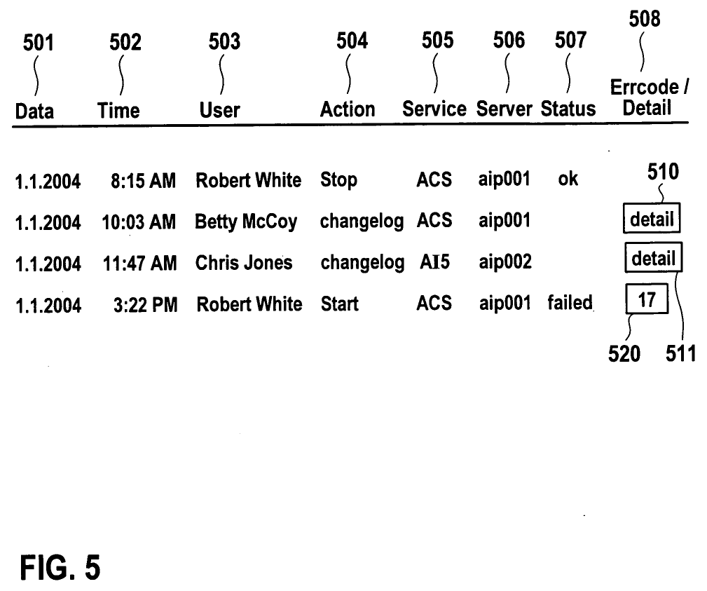

FIG. 5 displays an example of a log with 4 log entries having additional details. The log has 6 columns. The first 2 columns 501 and 502 specify date and time when the log entry was written. A user column 503 specifies persons responsible for the change that has resulted in the log entry. An action column 504 specifies activities that have caused the creation of the log entry. A service column 505 and a server column 506 specify identities of the affected server and services. A status column 507 specifies results of the activities indicated in the log entry. In the present example, the status is specified for log entries referring to a service activity. An Errcode/Detail column 508 either specifies standard error codes of failed activities or provides links to change data. In the present embodiment, the error codes are links to access the explanation for the error code. The first entry in the present example describes an activity of stopping a service that has been initiated by a service administrator. The next two log entries describe two separate setup changes of different servers as well as the affected services. Links 510 and 511 are provided to allow access to change data. The fourth entry describes a failure of an activity of a service. Tracking of the cause of the failure is possible in the following way. In the fourth entry, the error code 520 of the failed service indicates an error that has resulted from a setup change of a server. Starting from the fourth entry, the previous entry for the same service may be searched. In the present example, this means that the second entry, which is for the same service, is searched. Using the navigation link 510 of this entry, it is possible for the administrator to access the setup change data and to investigate the setup change more closely. In this way, the administrator may check if the setup change has caused the failure of the service.

In the present example, there is only one change entry for the failed service. It is, however, also possible that there is more than one relevant change entry. Using the log entries in the aforementioned manner, it is generally possible to track the possible causes of a failure, starting from the failed service, and to access the available information. In this way, the log provides an important tool for administrating a system of server and services.

It will be readily apparent to those skilled in this art that various changes and modifications of an obvious nature may be made, and all such changes and modifications are considered to fall within the scope of the appended claims. Other embodiments will be apparent to those skilled in the art from consideration of the specification and practice of the disclosure. It is intended that the specification and examples be considered as exemplary only, with a true scope and spirit of the disclosure being indicated by the following claims and their equivalents.

What is claimed is:

1. A method of administrating a computer system of at least one server and a plurality of services provided by the at least one server, the method comprising:
receiving input data, wherein the input date describe a setup change of a server and identify the server;
determining a service that is affected by the setup change, wherein the determining includes analyzing relations between the at least one server and the plurality of services provide by the as least one server;
writing an entry into a log, wherein the entry includes the input data that identify the server, identification of the determined service, and the input data that describe the setup change; and
using the log to administrate the computer system.

2. The method according to claim 1, wherein the writing of the entry into a log comprises writing the input data that identify the server and the identification of the determined service into a first part and writing the input data that describe the setup change into a second part, wherein the first part includes a navigation link to the second part.

3. A computer-readable medium having stored thereon computer program instructions for causing a computer to perform the method comprising:
receiving input data, wherein the input date describe a setup change of a server and identify the server;
determining a service that is affected by the setup change, wherein the determining includes analyzing relations between the at least one server and the plurality of services provide by the as least one server;
writing an entry into a log, wherein the entry includes the input data that identify the server, identification of the determined service, and the input data that describe the setup change; and
using the log to administrate the computer system.

4. The computer-readable medium according to claim 3, wherein the computer program includes further instructions for causing the computer to perform the method steps of writing the input data that identify the server and the identification of the determined service into a first part and writing the input data that describe the setup change into a second part, wherein the first part includes a navigation link to the second part.
